(19) United States
(12) Patent Application Publication
(10) Pub. No.: US 2007/0290027 A1
(43) Pub. Date: Dec. 20, 2007

(54) Ready-Made Food Package and a Method of Making It

(75) Inventors: Paivi Maatta, Imatra (FI); Panu Tanninen, Rauha (FI); Risto Vesanto, Imatra (FI)

Correspondence Address: BIRCH STEWART KOLASCH & BIRCH, PO BOX 747, FALLS CHURCH, VA, 22040-0747, US

(73) Assignee: Stora Enso OYJ, Finland (FI)

(21) Appl. No.: 10/590,996

(22) PCT Filed: Mar. 17, 2005
(86) PCT No.: PCT/FI05/00155

§ 371 Date: Jun. 4, 2007

(30) Foreign Application Priority Data
Mar. 18, 2004 (FI) 20040415

(51) Int. Cl. B65D 43/02; A23L 1/01; B65D 77/10

(52) U.S. Cl. 229/123.1; 426/115; 426/523

(57) ABSTRACT

The invention relates to a ready-made food package, to a method for manufacturing it and to the use of polymer-coated board in the ready-made food package. The package is manufactured by placing the food (16) in a raw state in the tray (2) where the food is baked, and by closing the tray with a lid (4) after baking. In accordance with the invention, the lid (4) is formed from a blank cut from polymer-coated board, the blank being placed over the mouth of the tray (2), and then the edges (9) of the blank are bent under the rim flange (6) of the tray and heat-sealed to the lower surface (11) of the rim flange by means of the polymer coating (14) of the board. The lid can be additionally heat-sealed to the upper surface (10) of the rim flange, so that two sealing lines (15) will be formed inside each other in the package. Accordingly, the tray (2) can be formed of polymer-coated board or optionally of polymer or aluminium alone.

The invention relates to a ready-made food package, which consists of a tray containing packaged food and a lid for closing the tray, in which at least the package lid is made of polymer-coated board. The invention also relates to a method for manufacturing such a ready-made package and to the use of the tray in the manufacture of the package.

By polymer coating a packaging material used in a ready-made food package, the inner surfaces of the package are given water-repellance and fat-resistance properties. The protective effect of the coating is important especially in a board package, which would otherwise be wetted and slacken under moisture absorbed from the food. If the polymer coating of the board is heat-sealable, the package can be sealed against water steam and/or oxygen depending on the barrier properties of the coating, so as to substantially increase the preservability of the food and to extend best-before date of the package.

DE patent application 3 940 161 discloses a food package of tray model which is made of polymer-coated board and is closed with a sealed lid. The package is intended primarily for autoclave sterilisation, and is additionally said to be suitable for heating in a microwave oven before intake of the food. The package lid may be made entirely of plastic or of board coated with polymer on both sides, with the coating layers extending over the edges of the board so as to form a border, at which the lid is sealed to the rim flange of the tray. In both cases, the plastic border of the lid is bent over the cutting edge of the tray edge against the lower surface of the rim flange, so that the edge surface, the so-called untrimmed mill edge, of the tray board is protected against moisture absorption occurring in an autoclave.

DE patent application 3 940 162 also depicts a food package having the form of a tray with a lid, which is intended to be heated and in which both the tray and the lid are made of polymer-coated board, cf. especially FIG. 21 of the publication. Since this package is not intended for autoclave use, the lid formed entirely of coated board is seamed at its edges to the rim flange of the tray, without protection of the untrimmed edges of the board as indicated above.

The food industry also manufactures ready-made food packages, in which the tray portion acts as a baking tray at the stage of cooking the food. The food is placed in the tray in a raw state, it is baked at the baking temperature and finally the tray containing the finished ready-made food is closed with a lid. The baking tray may be made of aluminium or a heat-resistant plastic, or board coated with a polymer whose fusion temperature is high enough to resist the food baking temperature without melting.

However, the baking of ready-made food trays have proved to involve the problem of hot grease tending to splatter from the food during baking, with a portion of the splashes ending on the rim flange of the tray. The rim flange has the function of acting as a counter-surface for the lid that is heat-sealed after baking in order to seal the package. Grease on the rim flange hampers sealing, resulting in a risk of leakage in the seal and causing premature deterioration of the food.

The invention has the purpose of providing a solution to the problem above, allowing jointing of a baking tray equipped with a rim flange and its closing lid by tight sealing, without causing sealing and leakage problems due to grease. The ready-made food package of the invention, which resolves the problem, is characterised by the food being baked in a tray included in the package and by the edges of the lid, by means of which the tray is closed after baking, being bent under the rim flange of the tray and heat-sealed to the lower surface of the rim flange by means of a polymer coating.

The lower surface of the rim flange, which, in accordance with the invention, acts as a counter-surface during heat-sealing of the lid, forms a part of the outer surface of the tray and is located in a dead area relative to splashes spreading from the tray, so that it is not significantly exposed to grease contamination. In other words, the sealability of the tray does not suffer under baking of food in the tray. In addition, bent and sealed under the rim flange of the tray, the lid edge will be efficiently protected against ruptures propagating from the edge during handling and transport of the packages.

In accordance with the invention, it is possible to seal the lid not only to the lower surface of the rim flange but also to the upper surface of the rim flange of the tray. Although, for the reasons explained above, sealing of the upper surface of the rim flange is less secure than sealing of its lower surface, this embodiment yields a package with two sealing lines inside each other, which have the joint effect of binding the lid more efficiently to the package.

In the package of the invention, the polymer coating on the inner surface of the board tray may consist particularly of polyesters, such as polyethylene terephtalate (PET), which resists food-baking temperatures. If necessary, the outer surface of the tray may also be polyester-coated. Instead of board, the tray may be entirely made of a polymer resisting the baking temperature, such as polyester or aluminium. The polymer coating of the inner surface of the lid to be fixed after the baking stage is preferably made of heat-sealable polymer, especially polyester or polypropene. A heat-sealing polymer whose fusion point is high enough allows heating of the package in an oven or a microwave oven before intake of the food.

In the method of the invention for manufacturing a ready-made food package as described above, the food is placed in a raw state in the board tray, it is then baked in the tray, and after baking the tray is closed with a lid, with the closing being performed in accordance with the invention by placing a board blank cut from polymer-coated board over the opening of the tray, by bending the blank edges under the rim flange of the tray and by finally heat sealing the blank edges to the lower surface of the rim flange of the tray by means of a polymer coating on the board. The lid blank may be equipped with creased folding lines, which substantially facilitate the bending of the edges of the blank.

The use of the tray made of polymer-coated board of the invention comprises the use of the tray as a baking tray in the manufacture of ready-made food packages, with the tray closed after baking with a lid made of polymer-coated board by bending the edges of the lid under the rim flange of the tray and by heat-sealing the edges to the lower surface of the rim flange by means of the polymer coating.

The invention is explained in further detail below by means of examples and with reference to the accompanying drawings, in which

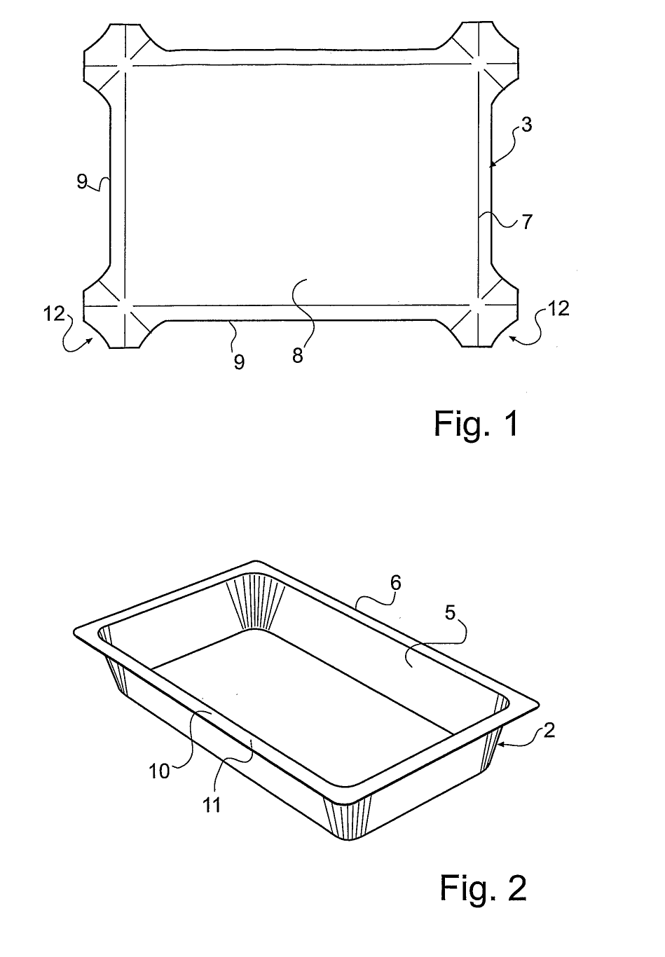

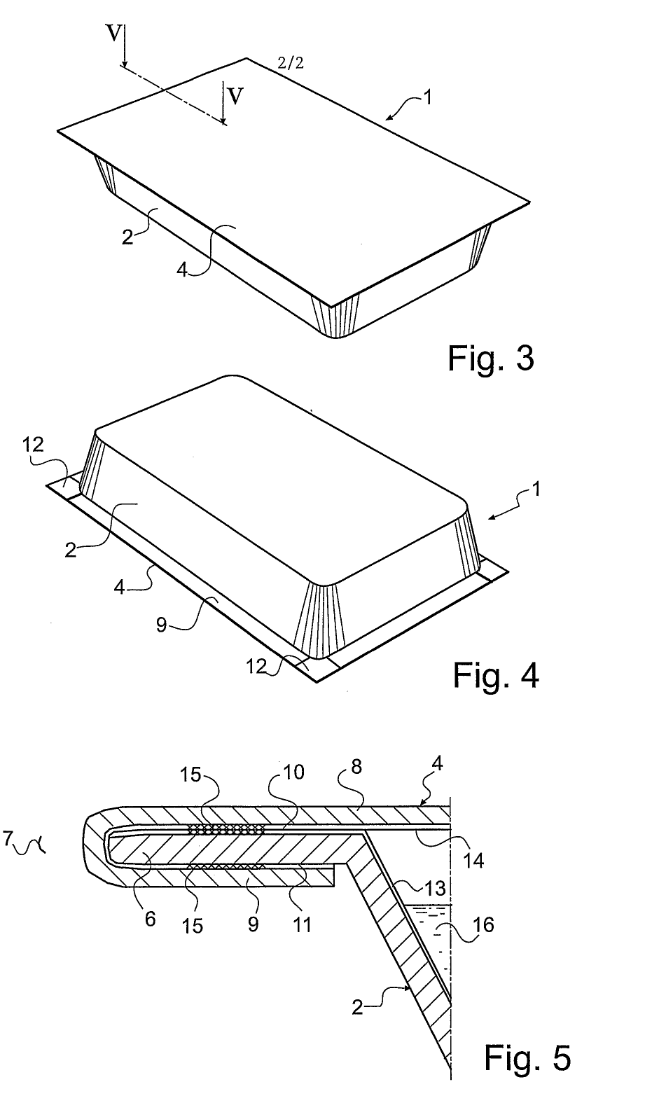

FIG. 1 shows a lid blank, which can be bent and sealed to form the lid of a ready-made food of the invention as illustrated in FIG. 3,

FIG. 2 shows a tray that can be sealed to the lid shown in FIG. 1 to form a package as shown in FIG. 3,

FIG. 3 shows a ready-made food package of the invention consisting of a tray and a closing heat-sealed lid, viewed obliquely from above, and

FIG. 4 shows accordingly the bottom side of the package of FIG. 3, and

FIG. 5 shows the seam point between the tray and the closing lid as a section V-V of FIG. 3.

The ready-made food package 1 shown in FIGS. 3 and 4 can be formed from the tray 2 of FIG. 2 and from the closing lid 4 formed of a blank 3 shown in FIG. 1. The tray 2 and the lid 4 are made of polymer-coated packaging board.

The opening of the tray 2 is principally rectangular and it comprises a horizontal protruding rim flange 6 surrounding the rim of the receptacle part 5 of the tray. The lid blank 3 is equipped with scores 7 acting as crease lines and dividing the blank into a rectangular central area 8 dimensioned to correspond to the rim flange 6 of the tray 2 and into lateral parts 9 surrounding it.

When the tray 2 of FIG. 2 is closed by the lid 4 formed out of the lid blank 3 in FIG. 1 in order to provide the package 1 illustrated in FIGS. 3 and 4, the central area 8 of the blank is placed so as to cover the opening of the tray and the upper surfaces 10 of the rim flange 6, and then the lateral parts 9 of the blank are bent around the edges of the rim flange against the lower surfaces 11 of the flange. In this manner, the lateral parts will form the pleats in the corners of the package 1 shown in FIG. 4, where the lid material is bent three-fold.

The material of the tray 2 is packaging board equipped with a polyester coating layer 13, which forms the inner surface of the tray. The lid 4 is made of packaging board, which is coated with a heat-sealable polyolefin layer 14, which forms the inner surface of the lid in the closed package. The lid 4, whose edge 9 is bent as in FIG. 5 against the lower surface 11 of the rim flange 6 of the tray 2, has been heat-sealed by means of the heat-sealable coating 14 both to the upper surface 10 and the lower surface 11 of the flange, so that the package will be closed by two sealing lines 15 placed inside each other on opposite sides of the flange.

The ready-made food package 1 is manufactured in accordance with the invention with the food 16 placed in a raw state in the open tray 2, where the food is baked at the required baking temperature without closing the tray. After the baking step, the tray 2 is closed with the lid formed from the blank 3 in FIG. 1 by bending the edges 9 of the blank around the rim flange 6 of the tray and by sealing the lid to the upper and lower surfaces 10, 11 of the flange in the manner described above. During the baking, grease may splatter from the food onto the upper surface of the rim flange 6, where it impedes the heat-sealing of the surface, but the sealing line 15 on the lower surface 11 of the flange ensures a tight seal in accordance with the invention.

It is obvious to those skilled in the art that the applications of the invention are not restricted to the one given as an example above, but may vary within the scope of the following claims. Thus, for instance, the coating polymers 13, 14 of the tray 2 and the lid 4 may differ from those mentioned above, and if desired, the outer surfaces of the tray and the lid can also be equipped with a polymer coating. The tray 2 can be entirely formed of polymer, such as polyethylene terephtalate, or aluminium, instead of coated board. It is also conceivable to seal the lid 4 to the rim flange 6 of the tray only on the lower surface 11 of the flange, and then the sealing line on the upper surface of the flange, which is less vital for the tightness of the package, is omitted.

1. A ready-made food package (1), which consists of a tray (2) containing the packaged food (16) and a lid (4) closing the tray, and in which at least the lid of the package is made of polymer-coated board, characterised in that the food (16) has been baked in the tray (2) included in the package and in that the edges (9) of the lid (4), by which the tray has been closed after baking, have been bent under the rim flange (6) of the tray and have been heat-sealed to the lower surface (11) of the rim flange by means of the polymer coating (14) of the lid.

2. A ready-made food package as defined in claim 1, characterised in that the lid (4) has additionally been heat-sealed to the upper surface (10) of the rim flange (6) of the tray (2).

3. A ready-made food package as defined in claim 1 or 2, characterised in that the inner surface (14) of the lid (4) is made of heat-sealable polymer, such as polyester.

4. A ready-made food package as defined in claim 1 characterised in that the tray (2) is made of polymer-coated board.

5. A ready-made food package as defined in claim 1 characterised in that inner surface (13) of the tray (2) is made of heat-resistant polymer, such as polyester.

6. A method for manufacturing a ready-made food package (1) as defined in claim 1, comprising the steps of placing the food (16) in a raw state in a tray (2) in which the food is baked, and after baking closing the tray with a lid (4), characterised in that closing is performed by placing a lid blank (3) cut from polymer-coated board over the mouth of the tray (2), by bending the edges (9) of the blank under the rim flange (6) of the tray and by heat-sealing the edges to the lower surface (11) of the rim flange by means of the polymer coating (14) of the board.

7. A method as defined in claim 6, characterised in that the lid (4) is also heat-sealed to the upper surface (10) of the rim flange (6) of the tray.

8. A method as defined in claim 6 or 7, characterised in that the lid blank (3) comprises creased folding lines (7), along which bending of the edges (9) is carried out.

9. Use of a tray made of polymer-coated board as a baking tray in the manufacture of ready-made food packages, comprising closing the tray (2) after baking with a lid (4) made of polymer-coated board, the edges (9) of the lid being bent under the rim flange (6) of the tray and heat-sealed to the lower surface (11) of the rim flange by means of the polymer coating (14).
